(19) United States
(12) Patent Application Publication
(10) Pub. No.: US 2026/0357744 A1
(43) Pub. Date: Nov. 12, 2026

(54) GROUNDING ASSEMBLIES FOR STRAY CURRENT PROTECTION

(71) Applicant: Cummins Power Generation Inc., Minneapolis, MN (US)

(72) Inventors: Raghuvaran Arumugam, Countesthorpe (GB); Kieran J. Richards, West Haddon (GB)

(73) Assignee: Cummins Power Generation Inc., Minneapolis, MN (US)

(21) Appl. No.: 19/204,022

(22) Filed: May 9, 2025

(51) Int. Cl. F02B 77/08

(52) U.S. Cl. CPC F02B 77/08

(57) ABSTRACT

Grounding systems are provided. The grounding system can include a grounding ring including a conductive body coupled with conductive microfibers configured to rotatably couple with a conductive component of the engine assembly. The grounding system can include a grounding ring carrier configured to retain the grounding ring against the conductive component.

### BACKGROUND

The present disclosure relates generally to grounding assemblies for reciprocating engines. For example, the engines can include bearings, such as bearings running against a crankshaft.

### SUMMARY

An embodiment of the present enclosure relates to a grounding system for an engine assembly, the grounding system including: a grounding ring including a conductive body coupled with conductive microfibers configured to rotatably couple with a conductive component of the engine assembly; and a grounding ring carrier configured to retain the grounding ring against the conductive component.

In some embodiments, the grounding ring carrier is configured to receive fasteners parallel to an axis of rotation of a crankshaft of the engine assembly to electrically and mechanically couple the conductive body of the grounding ring with the engine assembly.

In some embodiments, the grounding ring is a first grounding ring, the grounding system further including: a circlip; and a second grounding ring, wherein the grounding ring carrier and the circlip are configured to retain the first grounding ring and the second grounding ring against a component which is rotationally and electrically coupled with a crankshaft.

In some embodiments, the grounding system includes a deflection lip of a dust seal configured to deform according to a clamping force applied between a flywheel and a crankshaft.

An embodiment of the present enclosure relates to an engine assembly including: a crankshaft electrically coupled with an electrical source, the crankshaft configured to run against a plurality of main bearings; a grounding ring carrier configured to retain a grounding ring against a conductive component rotationally coupled with the crankshaft of the engine assembly; and the grounding ring.

In some embodiments, the grounding ring carrier is not rotationally coupled with the crankshaft.

In some embodiments, an electrical interface between the grounding ring and the crankshaft of the engine assembly consists essentially of conductive microfibers and a conductive coating disposed along a surface of the crankshaft.

In some embodiments, an electrical interface between the grounding ring and the crankshaft of the engine assembly includes a flywheel rotationally coupled with the crankshaft.

In some embodiments, the flywheel is electrically conductive between an inner portion mechanically coupled with the crankshaft and an outer portion electrically coupled with an alternator of the engine assembly.

In some embodiments, an electrical interface between the grounding ring and the crankshaft of the engine assembly includes a flywheel or a flex plate, rotationally coupled with the crankshaft and the electrical interface exhibits lower impedance than any path from the crankshaft to a main bearing.

In some embodiments, the engine assembly includes a flywheel rotationally coupled with the crankshaft, the flywheel electrically conductive between an inner portion mechanically coupled with the crankshaft and an outer portion electrically coupled with an alternator of the engine assembly.

In some embodiments, the grounding ring is a first grounding ring, the engine assembly further including: a second grounding ring, wherein the grounding ring carrier is configured to retain the first grounding ring and the second grounding ring against a component which is rotationally and electrically coupled with the crankshaft.

In some embodiments, the engine assembly includes a deflection lip of a dust seal, the deflection lip configured to deform according to a clamping force applied between the grounding ring carrier and a housing of the engine assembly.

In some embodiments, the engine assembly includes a deflection lip of a dust seal, the deflection lip configured to seal against the grounding ring carrier as retained by radial grooves or straps (e.g., a radial groove or straps of the flywheel).

In some embodiments, the grounding ring carrier circumscribes at least a portion of the crankshaft along a plane perpendicular to an axis of rotation of the crankshaft.

In some embodiments, the grounding ring carrier circumscribes an end of the crankshaft proximal to a flywheel of the engine assembly.

In some embodiments, the grounding ring carrier is installed at an end of the crankshaft distal to a flywheel of the engine assembly.

An embodiment of the present enclosure relates to a method, including: installing a grounding ring circumscribing a crankshaft of an engine assembly to form a first conductive path passing through the crankshaft and the grounding ring, wherein the first conductive path exhibits lower resistance than any second conductive path passing from the crankshaft to an engine cover through a main bearing.

In some embodiments, the first conductive path includes: a flywheel housing of the engine cover or a gear cover of the engine cover.

In some embodiments, the grounding ring is electrically coupled with: the crankshaft by a silver-coated portion of the crankshaft; and a flywheel housing of the engine assembly by a grounding ring carrier, wherein at least a portion of the grounding ring carrier is disposed between the flywheel housing and a flywheel and the grounding ring carrier is bolted to an outer face of the flywheel housing.

In some embodiments, the techniques described herein relate to a method, wherein the grounding ring is electrically coupled with: the crankshaft by a silver-coated portion of the crankshaft; and a gear housing of the engine assembly by a grounding ring carrier bolted to an outer face of the gear housing.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a grounding system for an engine assembly provided according to an exploded view, according to some embodiments.

FIG. 2 is a grounding diagram provided according to a cross-sectional view of the assembled engine assembly of FIG. 1, according to some embodiments.

FIG. 3 depicts a profile view of a grounding system for an engine assembly, according to some embodiments.

FIG. 4 is a grounding diagram provided according to a cross-sectional view of the assembled engine assembly of FIG. 3, according to some embodiments.

FIG. 5 is a grounding diagram provided according to a cross-sectional view of an engine assembly, according to some embodiments.

FIG. 6 is another grounding diagram provided according to a cross-sectional view of an engine assembly, according to some embodiments.

FIG. 7 is an exploded view of a grounding system, according to some embodiments.

FIG. 8 is a profile view of a grounding system coupled with an engine assembly, according to some embodiments.

FIG. 9 is a flow diagram for a method of grounding system installation, according to some embodiments.

FIG. 10 depicts an example grounding ring according to a cross-sectional view of an assembled engine assembly, according to some embodiments.

FIG. 11 is a grounding diagram provided according to a cross-sectional view of an assembled engine assembly, according to some embodiments.

### DETAILED DESCRIPTION

Following below are more detailed descriptions of various concepts related to, and implementations of, systems and methods to provide low impedance paths to mitigate stray current-induced bearings wear, such as for bearings running against a crankshaft. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Vehicle operation can induce stray currents, such as those originating from alternators, inverters, or other components of a propulsion or related system. For example, some stray currents can be sourced from an alternator coupled with a starter enmeshed with gears along an outer circumference of a flywheel. These stray currents can cross couple with one another, interfere with electronic devices, or lead to premature bearing wear, among other issues. For example, where the stray currents couple into a crankshaft of an engine, the currents can cross (generally insulating) oil films. Such boundary crossing can be accelerated where the oil film thins or fails, such as under heavy loads, or when the oil film becomes conductive, such as when contaminated with soot or metallic particles. Accordingly, such electro-pitting can promote positive feedback in wear of bearings or other mechanical components, such that the use cases leading to high soot loads or metallic particles can lead to accelerated arcing wear. Ground straps or other grounding elements can provide low-impedance paths to ground stray currents. However, preventive maintenance of such components is sometimes indefinitely deferred, and ground straps are sometimes removed during maintenance operations without appropriate replacement. Moreover, ground strap conductance may be insufficient to shunt stray currents in some applications, or may be unsuitable for some environments, such as mining, where the ground strap itself can become coated in conductive dusts or fluids.

According to the present disclosure, a grounding ring is electrically coupled with a crankshaft. For example, the grounding ring can electrically couple with an end of the crankshaft (e.g., a snout of the crankshaft at a front of the engine proximal to the flywheel, or a flange of the crankshaft at a rear of the engine proximal to a gear cover). The electrical coupling of the grounding ring with the crankshaft can include a brush-like contact of conductive microfibers. The brushes (e.g., conductive microfibers) can contact the crankshaft at a location between the grounding ring and the crankshaft, or can include intermediate components rotationally coupled with the crankshaft. In some embodiments, the rotationally coupled components are configured to mechanically retain the grounding ring against the crankshaft or any intermediate components.

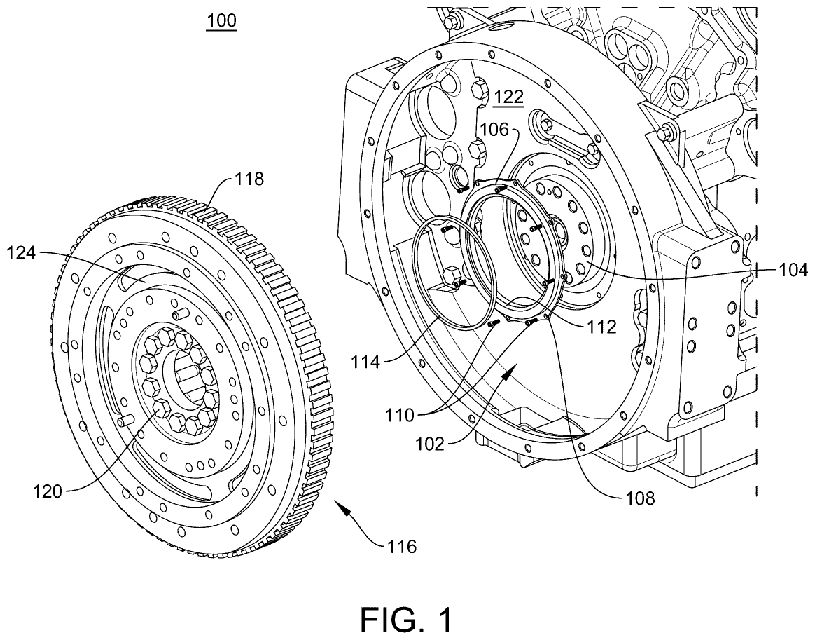

Referring now to FIG. 1, an illustrative example of a grounding system 102 for an engine assembly 100 is provided according to an exploded view. The engine assembly 100 includes a crankshaft 104 electrically coupled with an electrical source, such as an alternator or other component of an electrical system of the engine assembly 100. The engine assembly includes a crankshaft 104 configured to run against bearings, such as various main bearings, thrust bearings, and so forth.

The grounding system 102 includes a grounding ring 112 having a conductive body coupled with conductive microfibers configured to rotatably couple with a conductive component of the engine assembly 100 (e.g., a crankshaft 104). The grounding system 102 includes a grounding ring carrier 106 configured to retain the grounding ring 112 against the conductive component. For example, the grounding ring carrier 106 can retain the conductive microfibers on an inner surface of the grounding ring 112 against an outer surface of a snout of the crankshaft 104 protruding from an engine block of the engine assembly 100. The snout of the crankshaft 104 can, in turn, couple with an inner surface of a flywheel 116. Although depicted in an exploded configuration, when assembled, the grounding ring carrier 106 can circumscribe at least a portion of the crankshaft 104 along a plane perpendicular to an axis of rotation of the crankshaft 104. For example, the grounding ring carrier 106 can circumscribe an end of the crankshaft proximal to a flywheel 116 of the engine assembly 100. In some embodiments, the grounding ring 112 can circumscribe at least a portion of the crankshaft 104, exterior to the grounding ring carrier 106.

The flywheel 116 includes an outer portion 118 as can couple with a starter motor electrically coupled with an alternator or other electrical source of stray currents. Accordingly, the outer portion 118 can be referred to as electrically coupled with the alternator or other electrical source. The flywheel 116 includes an inner portion 120 as can mechanically couple with the crankshaft 104. For example, the inner portion 120 can include fasteners coupled with an outer surface of the snout of the crankshaft 104, so that the inner portion is mechanically coupled with the crankshaft 104. The flywheel 116 includes a medial portion 124 joining the outer portion 118 with the inner portion 120. For example, the medial portion 124 can transmit mechanical forces related to actuation of the starter motor from the outer portion 118 to the inner portion 120, or electrical currents from any of various electrical sources to the inner portion 120. These electrical currents can pass on to the crankshaft 104, and damage bearings coupling with the crankshaft 104, but may be shunted by application of the grounding system 102.

In some embodiments, the snout of the crankshaft 104 extends beyond a front crankshaft seal 206 (e.g., the grounding system 102 can be disposed outside of a pressurized oil cavity of the crankcase lubricated region). However, residual oil may still be present in this region due to proximity to internal lubrication zones or for splash lubrication of components. Accordingly, the grounding system 102 can include seals 114 to prevent the ingress of oil into the interface between the grounding ring 112 and the crankshaft 104. Moreover, the grounding system 102 can include seals to prevent the ingress of dust to avoid contamination of the oil, or to interfere with the interface between the grounding ring 112 and the crankshaft 104.

In some embodiments, one or more components of the grounding system 102 is disposed within a partially submerged, splash lubricated, or other portion of the engine assembly. For example, the grounding system 102 can be disposed within a gear housing of the engine assembly 100 at an opposite end of the crankshaft 104 from the snout. Accordingly, the seals 114 for the grounding system 102 can define boundaries between oil regions of the engine assembly (e.g., between pressurized and non-pressurized regions, submerged and non-submerged regions, or so forth).

The grounding ring carrier 106 can include openings 108 to receive fasteners 110 to couple the conductive body of the grounding ring 112 with the engine assembly 100 (e.g., an engine housing 122 (and/or engine enclosure 122) for the engine). For example, the grounding ring carrier 106 openings 108 can include fully or partially annular openings 108 to receive fasteners 110 parallel to an axis of rotation of the crankshaft 104 of the engine assembly 100. The coupling of the grounding ring 112 with the engine assembly 100 can include electrical coupling (e.g., to shunt stray currents away from an interface between the crankshaft 104 and bearings running against the crankshaft 104). The coupling of the grounding ring 112 with the engine assembly 100 can include mechanical coupling (e.g., to apply a clamping force to prevent rotation of the grounding ring 112 incident to rotation of the crankshaft 104). Accordingly, in some embodiments, the grounding ring carrier 106 is not rotationally coupled with the crankshaft 104.

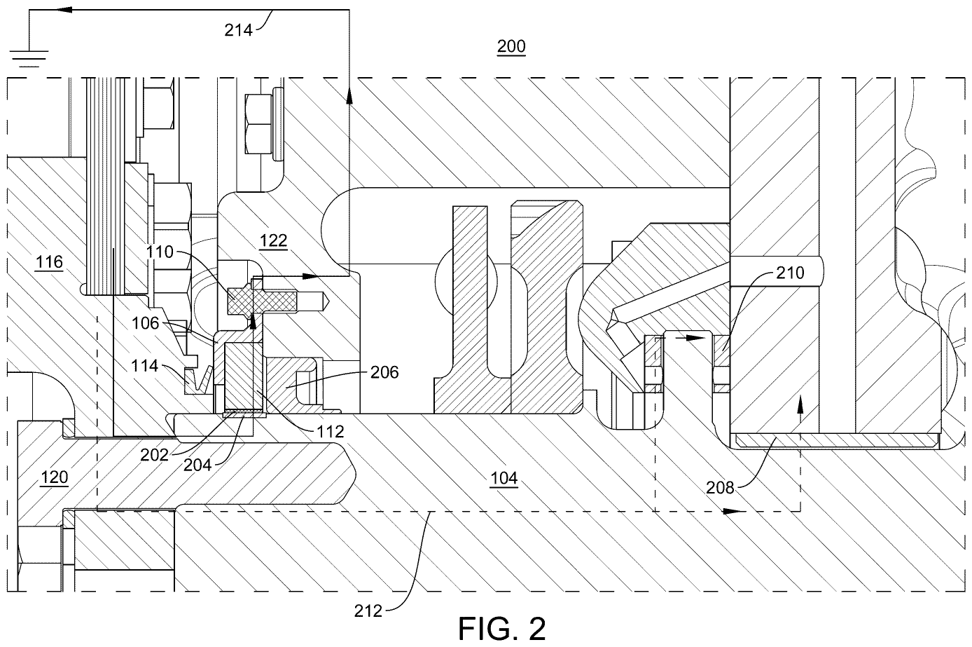

FIG. 2 is an illustrative example of a grounding diagram 200 provided according to a cross-sectional view of the assembled engine assembly 100 of FIG. 1. The grounding ring carrier 106 is depicted as coupled with the engine housing 122 using fasteners 110 extending parallel to the axis of rotation of the crankshaft 104. The grounding ring carrier 106 can retain microfibers 202 along an inner surface of the grounding ring 112 against an outer surface of the crankshaft 104. For example, the grounding ring carrier 106 can include a circlip or a retaining wall to clamp the grounding ring 112 against the engine housing 122. The grounding ring carrier 106 can include or mate with one or more seals 114, as may be provided similarly to a circlip, interior or exterior to the grounding ring. For example, an external seal 114 can prevent oil contamination from reaching an interface between the grounding ring 112 and the crankshaft 104. An external seal 114 can prevent dust contamination from reaching the interface.

The outer portion of the crankshaft 104 can be coated with a conductive coating 204 to reduce a contact impedance between the crankshaft 104 and the grounding ring 112. The conductive coating 204 can include a material having lower resistance than the crankshaft 104 (e.g., a steel crankshaft 104), and can further include anti-oxidation properties. For example, the conductive coating 204 can include silver as can be electroplated or otherwise coated along the portion of the crankshaft 104 in contact with the conductive microfibers 202. The grounding system can include a seal 114, such as a dust seal 114. The seal 114 can include a deflection lip. The deflection lip can seal against the grounding ring carrier 106. In some embodiments, at least a portion of the seal can be retained through radial grooves or straps, or axially restrained between the flywheel 116 and the grounding ring carrier 106. Such an assembly can aid to maintain sealing at high engine speeds. In some embodiments, the seal 114 is configured to deform according to a clamping force applied between the flywheel 116 and the crankshaft 104. The deformation of the deflection lip can impair ingress of dust beyond the seal 114 as can interfere with an electrical interface between the microfibers 202 and the crankshaft (e.g., the conductive coating 204).

The crankshaft 104 can run against one or more bearings, such as one or more main bearings 208 and one or more thrust bearings 210. Where the grounding system 102 (e.g., the grounding ring 112) is omitted, stray currents can couple across an interface between the crankshaft 104 and the bearings, such as the main bearings 208 or the thrust bearings 210. For example, a current path 212 can pass through the crankshaft 104 and across the bearings, which may cause pitting from electrical arcing. The stray currents can be generated by an alternator, starter, cooling fans, or welding operations on the engine assembly 100 or a vehicle including the engine assembly 100. The stray currents can electrically couple from an alternator or other electrical source and on to the crankshaft 104. Where the grounding system 102 is included, the grounding ring 112 can form a low impedance path 214 to shunt current away from the current path 212. Because the current path 212 can extend through or pass across at least one interface between the crankshaft 104 and the bearings 208, 210, shunting current away from such a path can prevent currents from arcing to, heating, or otherwise damaging faces of the bearings 208, 210.

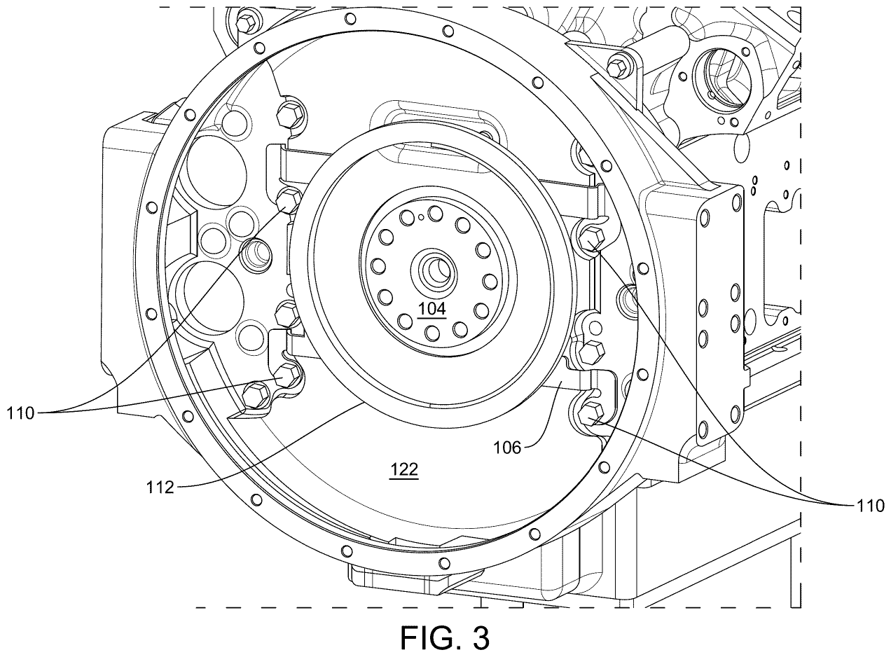

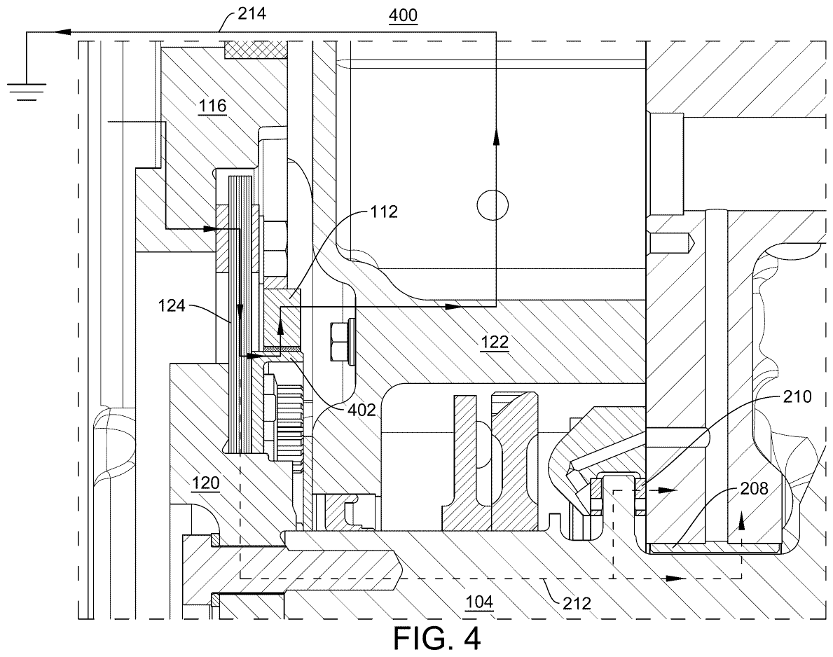

In the depicted illustrative example, the electrical interface between the body of the grounding ring 112 and the crankshaft 104 of the engine assembly 100 consists essentially of conductive microfibers 202 and the conductive coating 204 disposed along a surface of the crankshaft 104. In some embodiments, the electrical interface can include additional conductive components between the grounding ring 112 and the crankshaft 104 along the low impedance path 214. An example of such a system is provided hereinafter at FIGS. 3-4.

The grounding system 102 can include a circlip or other retainer to couple one or more of the grounding rings 112 against the engine housing 122. For example, the circlip can include a semi-flexible, ring-shaped fastener made of spring steel or another resilient material configured to retain the grounding ring 112 relative to the crankshaft or another rotating component of the engine assembly 100. The circlip can be received into the grounding ring carrier 106 such that the circlip can be present in another cut plane in front of or behind the depicted cross-sectional view. The depicted grounding ring 112 can include one or more constituent portions. For example, the grounding ring 112 can include constituent portions of an inner grounding ring 112 (right as depicted) and outer grounding ring 112 (left as depicted). Additional grounding rings 112 can be stacked along an axis of the crankshaft 104 to realize decreased impedance of the low impedance path 214, or fewer grounding rings can be included to reduce a thickness of the stack-up. The grounding ring carrier 106 and circlip can retain the first grounding ring 112 and the second grounding ring 112 against a component which is rotationally and electrically coupled with the crankshaft 104 (e.g., the flywheel 116).

FIG. 3 depicts a profile view of an illustrative example of a grounding system 102 installed on an engine assembly 100. The present example includes a grounding ring carrier 106 configured to retain a grounding ring 112 (e.g., one or more grounding rings 112). More particularly, the grounding ring carrier 106 can retain the grounding ring 112 concentrically circumscribing, but not in contact with, the crankshaft 104. Further depicted are fasteners 110 configured to couple the grounding ring carrier 106 with the engine housing 122. Such fasteners 110 can mechanically couple the grounding ring carrier 106 with the engine housing 122 to maintain a position of the grounding ring carrier 106. For example, the fasteners 110 can retain the grounding ring carrier 106 rigidly, or the grounding ring carrier 106 can be somewhat flexible to deform to couple an inner surface of the one or more grounding rings 112, with a further conductive element in contact therewith (e.g., the flywheel 116). Moreover, the fasteners 110 can electrically couple the flywheel to the engine housing 122, to provide a return path for stray currents.

FIG. 4 is an illustrative example of a grounding diagram 400 provided according to a cross-sectional view of the assembled engine assembly 100 of FIG. 3. As referred to above, the grounding ring carrier 106 retains the grounding ring 112 circumscribing, but not in contact with, the crankshaft 104. In some embodiments, the grounding ring carrier 106 can retain the grounding ring 112 as laterally offset, along an axis of rotation of the crankshaft 104, from the crankshaft 104. Accordingly, the engine assembly 100 (e.g., the flywheel 116) can include a conductive portion 402. The conductive portion 402 can extend parallel to the axis of rotation of the crankshaft 104 to electrically couple with the grounding ring 112 (e.g., the microfibers 202 of the grounding ring 112). In some embodiments, the grounding ring carrier 106 can retain the grounding ring 112 circumscribing the crankshaft 104 but axially offset from the crankshaft 104 (e.g., leftward from the crankshaft, as depicted). The conductive portion 402 can extend along any such axial offset to provide an interface between the grounding ring 112 and the flywheel 116.

The conductive portion 402 can shunt a current path 212 including the crankshaft 104. For example, the shunted path can include an interface between the crankshaft 104 and its bearings 208, 210). Moreover, the interface between the conductive portion 402 and the flywheel 116 can close a low impedance path 214 from the flywheel 116, as can close a return path from stary currents induced by a starter or alternator. That is, the electrical interface between the grounding ring 112 and the crankshaft 104 of the engine assembly 100 can include the flywheel 116, the flywheel 116 being rotationally coupled with the crankshaft 104. The one or more portions of the flywheel 116 can be provided as steel, as can provide rotational inertia to smooth engine pulses, and electrical connectivity. For example, the flywheel 116 can be electrically conductive between an inner portion 120 (including any fasteners) mechanically coupled with the crankshaft 104 and an outer portion 118 electrically coupled with an alternator of the engine assembly.

The electrical interface between the grounding ring 112 and the crankshaft 104 of the engine assembly 100 can include a flywheel 116 or a flex plate, rotationally coupled with the crankshaft 104 and the electrical interface exhibits lower impedance than any path from the crankshaft to a main bearing 208.

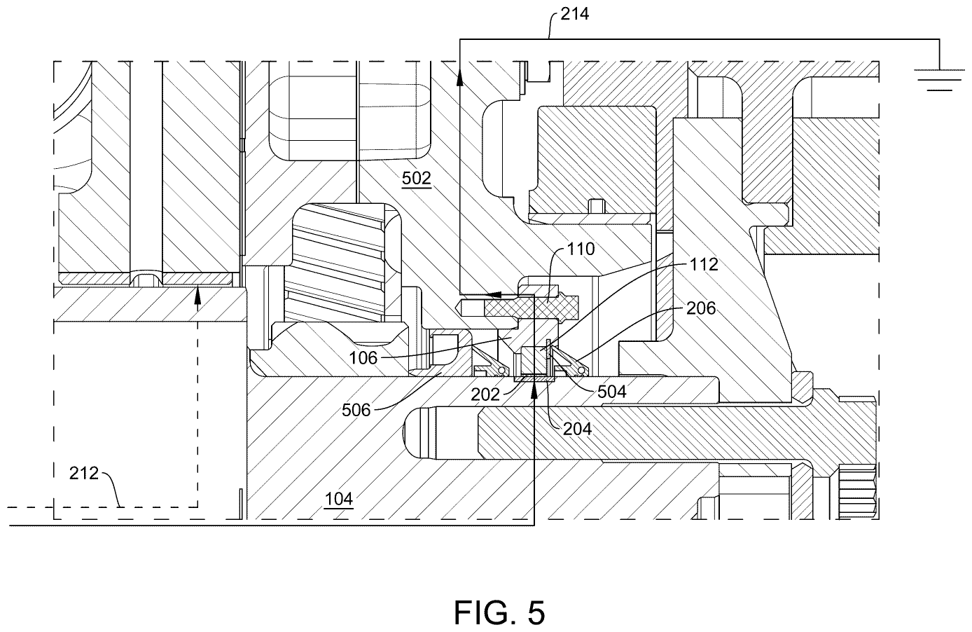

FIG. 5 is an illustrative example of a grounding diagram provided according to a cross-sectional view of an engine assembly 100. More particularly, FIG. 5 depicts a view of a rear end of the crankshaft 104, distal from the flywheel 116. A grounding ring 112 is installed at the end of the crankshaft 104, distal from the flywheel 116. This grounding ring 112 can be provided in addition to, or instead of, any of the grounding rings 112 depicted in FIGS. 1-4. A low impedance path 214 can extend, from the flywheel 116, axially along the length of the crankshaft to the rear end of the crankshaft 104, towards a gearbox 502 of the engine housing 122. Such a low impedance path 214 can shunt current away from another current path 212 extending across an interface between the crankshaft 104 and its bearings (e.g., main bearings 208 or thrust bearings 210).

The grounding ring carrier 106 can retain the grounding ring 112 against the crankshaft 104. For example, a circlip 504 can retain the grounding ring 112 against a retaining wall of the grounding ring carrier 106 to maintain microfibers 202 in electrical contact with the crankshaft 104 (e.g., a conductive coating 204 on the crankshaft 104).

Various seals can protect the grounding ring 112 from the ingress of dust from an exterior of the engine assembly 100 or oil from the interior of the engine assembly 100. For example, a main seal 506 can intermediate the grounding ring 112 from a pressurized portion of the engine, and one or more further seals 114 can protect the grounding ring 112 from any oil. For example, one seal 114 can protect the grounding ring 112 from any oil leaking past the main seal 506 and another seal 114 can protect the further seals 114 from exterior contaminants.

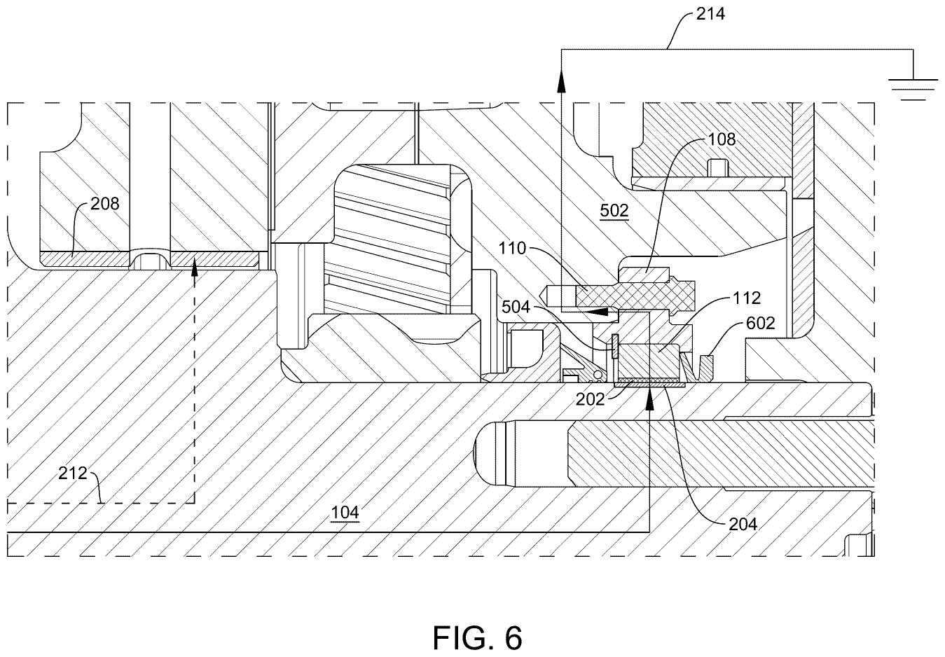

FIG. 6 is an illustrative example of a grounding diagram provided according to a cross-sectional view of the assembled engine assembly 100, including various overlapping features with the engine assembly of FIG. 5. In the depicted view, one of the seals 114 of FIG. 5 is substituted for a wiper seal 602 to exclude contaminants from internal portions of the engine assembly 100 interior. Moreover, the depicted example includes a first grounding ring 112 and a second grounding ring 112 (depicted as laterally centered on the low impedance path 214). The grounding ring carrier 106 is configured to retain the first grounding ring 112 and the second grounding ring 112 against the crankshaft 104, or another component which is rotationally and electrically coupled with the crankshaft 104.

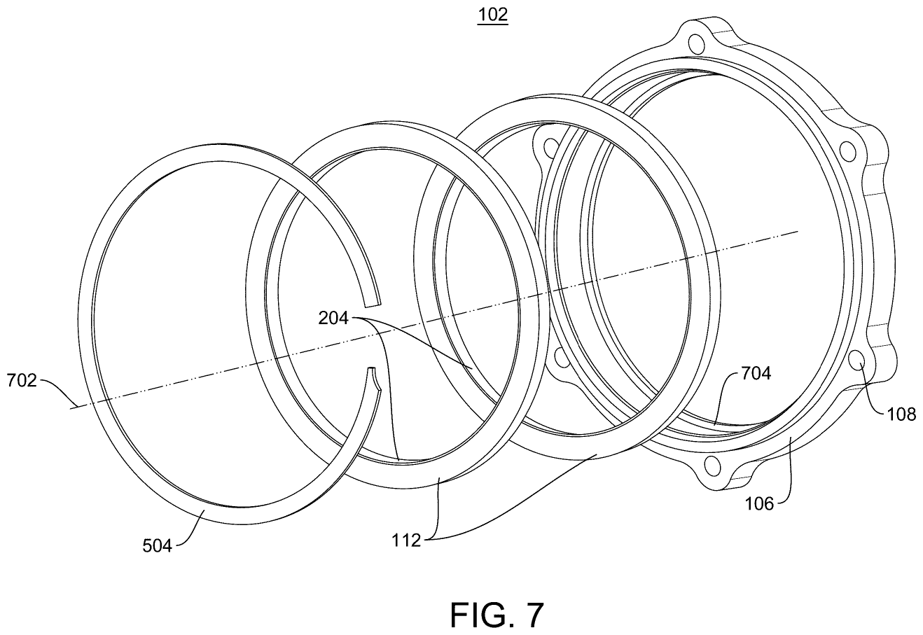

FIG. 7 is an exploded view of an illustrative example of a grounding system 102. More particularly, the depicted illustrative example can couple with a rear of an engine assembly 100. The grounding system 102 includes a grounding ring 112 having a conductive body coupled with conductive microfibers 202 configured to rotatably couple with a conductive component of the engine assembly 100 (e.g., a crankshaft 104 or a flywheel 116). The grounding system 102 includes a grounding ring carrier 106 configured to retain the grounding ring 112 against the conductive component. For example, the grounding ring carrier 106 can include openings 108 to receive fasteners 110, as depicted in each of FIGS. 1-6.

Each of the grounding rings 112 are depicted as centered on an axis of rotation 702 for the crankshaft 104 or flywheel 116 of an engine assembly 100. The grounding ring carrier 106 can receive the grounding ring 112 against a retaining wall 704 to maintain the grounding rings 112 along an axial portion of the crankshaft 104. A shoulder of the grounding ring carrier 106 can align the grounding rings 112 to fit over the crankshaft 104 (e.g., a crankshaft 104 snout, as in FIGS. 1-4, or a crankshaft 104 flange, as depicted in FIGS. 5-6). The grounding system 102 can be assembled during installation, such that the crankshaft 104 can self-align one or more grounding rings 112. In some cases, the grounding system 102 can be assembled prior to installation, such that a circlip 504 can be attached on an inner side of the grounding rings 112 as spaced from the main seal 506 (e.g., to allow room for an offset distance or further seal 206).

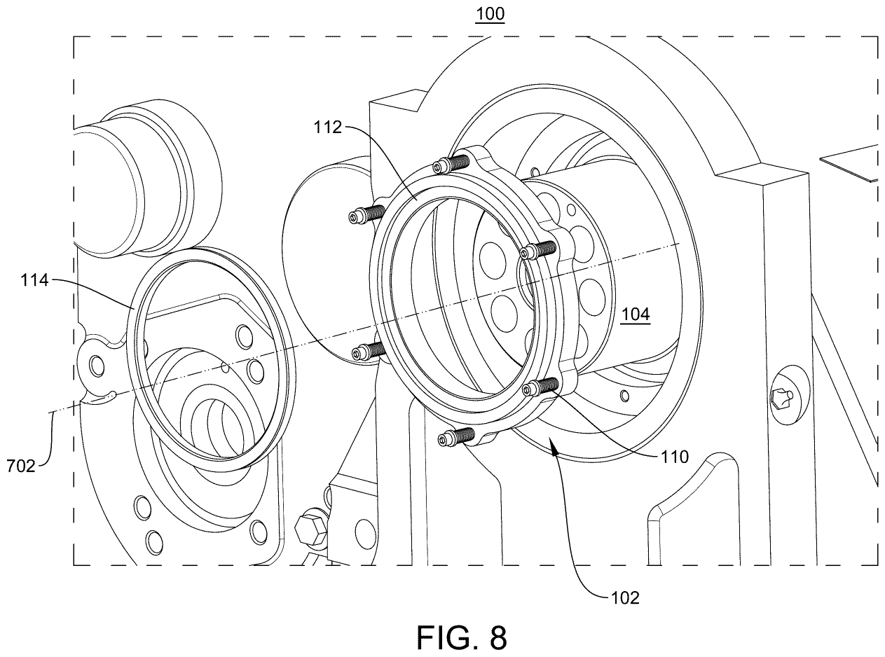

FIG. 8 is an illustrative example of a profile view of a grounding system 102 coupled with an engine assembly 100. More particularly, the depicted illustrative example can couple with a front of an engine assembly 100. The grounding system 102 includes a grounding ring carrier 106 having at least one grounding ring 112 stored therein. A seal 114 is provided along a front of the engine assembly 100. The various components of the grounding system 102 are provided as aligned concentrically with the crankshaft 104.

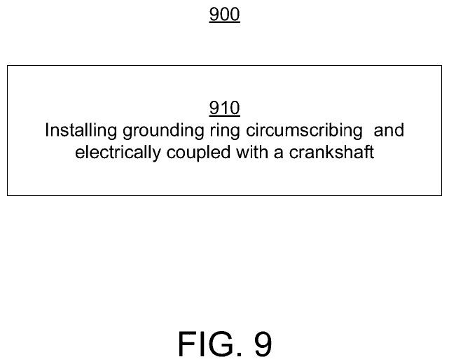

FIG. 9 is an illustrative example of a flow diagram for a method 900 of grounding system 102 installation, according to some embodiments. The method 900 can be performed at a front or rear of an engine assembly 100 with various of the illustrative examples described herein, combinations thereof, or further variants.

At operation 910, the method 900 includes installing a grounding ring circumscribing a crankshaft 104 of an engine assembly 100 to form a first conductive path 214 passing through the grounding ring 112, wherein the first conductive path 214 exhibits lower resistance than any second conductive path 212 passing from the crankshaft to an engine cover through a main bearing. In some embodiments, the first conductive path 214 or the second conductive path 212 extends through the crankshaft. Accordingly, the installation of the grounding ring 112 can shunt currents away from bearings running against the crankshaft 104 to prevent arcing-related pitting or other damage to the bearings. In some embodiments, the first conductive path 214 includes a flywheel housing of the engine cover or a gear cover of the engine cover.

In some embodiments, when installed with a grounding ring carrier 106, the grounding ring 112 is electrically coupled with the crankshaft 104 by a silver-coated portion of the crankshaft 104, and with a flywheel housing of the engine assembly 100. The grounding ring carrier 106 can be installed at a front of an engine assembly 100. For example, at least a portion of the grounding ring carrier 106 can be disposed between the flywheel housing and a flywheel 116 and the grounding ring carrier 106 is bolted to an outer face of the flywheel housing. The grounding ring carrier 106 can be installed at a rear of an engine assembly 100. For example, the grounding ring, when installed, can electrically couple with the crankshaft by a silver-coated portion of the crankshaft and a gear housing of the engine assembly by a grounding ring carrier 106 bolted to an outer face of the gear housing.

In some embodiments, the present method 900 is performed during manufacture of an engine assembly 100. In some embodiments, the present method 900 is performed in a retrofit application. For example, the grounding system 102 can be provided along with a mated flywheel 116 for installation in retrofit applications, wherein the mated flywheel 116 is provided to mechanically receive the grounding system 102 between the flywheel 116 and the crankshaft 104. Such applications can replace other systems, such as non-conductive flywheels 116 (e.g., flywheels including a carbon-fiber medial portion 124 to transmit mechanical forces between the inner portion 120 and the outer portion 118 without transmitting electrical currents therebetween to avoid electrically coupling the starter or alternator with the crankshaft 104).

A method of grounding system 102 operation is provided according to some embodiments. The method can be performed with various of the illustrative examples described herein, combinations thereof, or other variants thereof. The method can discharge an electromotive potential, as can be sourced by an alternator, starter, or other components of the engine assembly 100.

The method can include discharging an electromotive potential along a first conductive path 214 including a grounding ring 112 exhibiting lower resistance than any second conductive path 212 passing from the crankshaft 104 to the engine enclosure 122 through a main bearing 208 or a thrust bearing 210. For example, the first conductive path 214 can pass through the crankshaft 104 and a grounding ring 112 circumscribing the crankshaft 104. In some embodiments, the potential is discharged to a flywheel housing of the engine enclosure 122 or a gear cover of the engine enclosure 122.

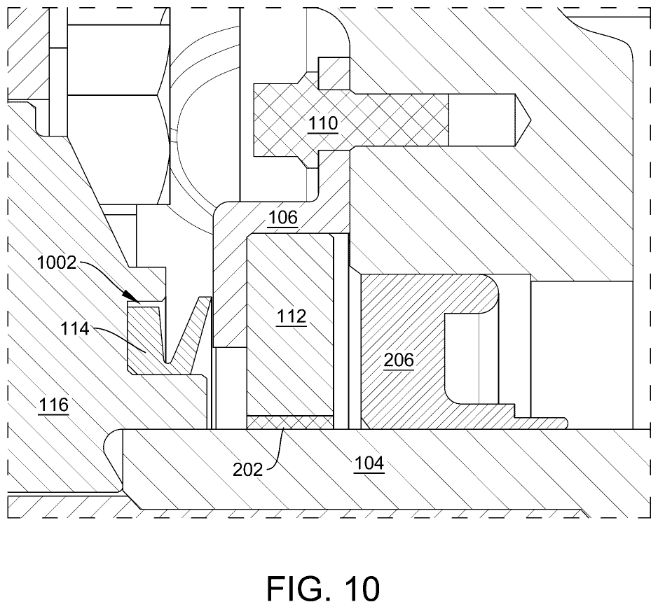

FIG. 10 depicts an example grounding ring 112 according to a cross-sectional view of an assembled engine assembly 100, according to some embodiments. A grounding ring carrier 106 couples the grounding ring 112 with the engine assembly 100 to maintain microfibers 202 against the rotating crankshaft 104 (or another component rotationally coupled therewith). A flywheel 116 (e.g., an inner portion 120 thereof) can include a radial retention cavity 1002 for a seal 114, such as a dust seal 114, as may be implemented as a v-ring, as depicted. The inclusion of the seal 114 within the radial retention cavity 1002 (sometimes referred to as a radial groove, without limiting effect) can promote retention of the seal 114 against the grounding ring carrier 106 at high rotational crankshaft speeds. For example, as described above, the deflection lip can seal against the grounding ring carrier 106. In some embodiments, at least a portion of the seal can be retained through radial grooves or straps, or axially restrained between the flywheel 116 and the grounding ring carrier 106. Such an assembly can aid to maintain sealing at high engine speeds.

Reductions in friction between the seal 114 and the grounding ring carrier 106 can further promote retention. For example, at least a surface of the grounding ring carrier 106 can be adapted to reduce friction. For example, the surface can include a dry film lubricant (e.g., Molybdenum Disulfide (MoS2) or Polytetrafluoroethylene (PTFE)).

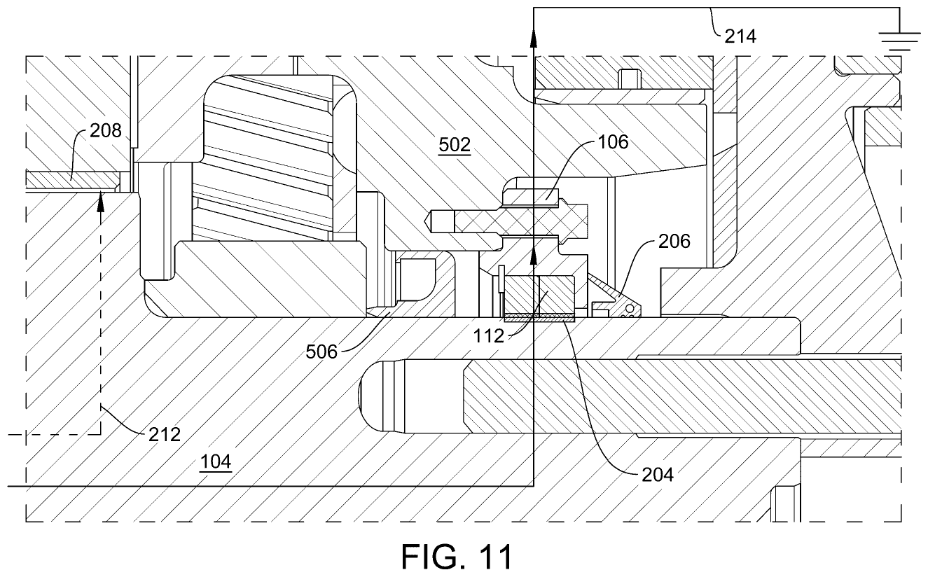

FIG. 11 is a grounding diagram provided according to a cross-sectional view of an assembled engine assembly 100, according to some embodiments. For example, the engine assembly 100 can include various overlapping (e.g., same or similar) components as depicted in, for example, FIGS. 5 and 6. According to the depicted embodiment, a further seal is omitted between the main seal 506 and components of the grounding system 102 including the grounding ring carrier 106 or the grounding ring 112. A dust seal 206 is provided along an outer surface of the grounding ring carrier 106 or the grounding ring 112 to prevent an ingress of dust (or egress of oil which seeps from the main seal 506).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining can be stationary (e.g., permanent or fixed) or moveable (e.g., removable or releasable). Such joining can be achieved with the two members coupled directly to each other, with the two members coupled with each other using one or more separate intervening members, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic. For example, circuit A communicably “coupled” to circuit B can signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements can differ according to other exemplary embodiments, and that such variations are intended to be encompassed by the present disclosure. The term “or,” as used herein, is used in its inclusive sense (and not in its exclusive sense) so that when used to connect a list of elements, the term “or” means one, some, or all of the elements in the list.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems and methods as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A grounding system for an engine assembly, the grounding system comprising:
a grounding ring comprising a conductive body coupled with conductive microfibers configured to rotatably couple with a conductive component of the engine assembly; and
a grounding ring carrier configured to retain the grounding ring against the conductive component.

2. The grounding system of claim 1, wherein the grounding ring carrier is configured to receive fasteners parallel to an axis of rotation of a crankshaft of the engine assembly to electrically and mechanically couple the conductive body of the grounding ring with the engine assembly.

3. The grounding system of claim 1, wherein the grounding ring is a first grounding ring, the grounding system further comprising:
a circlip; and
a second grounding ring, wherein the grounding ring carrier and the circlip are configured to retain the first grounding ring and the second grounding ring against a component which is rotationally and electrically coupled with a crankshaft.

4. The grounding system of claim 1, further comprising a deflection lip of a dust seal configured to deform according to a clamping force applied between a flywheel and a crankshaft.

5. An engine assembly comprising:
a crankshaft electrically coupled with an electrical source, the crankshaft configured to run against a plurality of main bearings;
a grounding ring carrier configured to retain a grounding ring against a conductive component rotationally coupled with the crankshaft of the engine assembly; and
the grounding ring.

6. The engine assembly of claim 5, wherein the grounding ring carrier is not rotationally coupled with the crankshaft.

7. The engine assembly of claim 5, wherein an electrical interface between the grounding ring and the crankshaft of the engine assembly consists essentially of conductive microfibers and a conductive coating disposed along a surface of the crankshaft.

8. The engine assembly of claim 5, wherein an electrical interface between the grounding ring and the crankshaft of the engine assembly comprises a flywheel rotationally coupled with the crankshaft.

9. The engine assembly of claim 8, wherein the flywheel is electrically conductive between an inner portion mechanically coupled with the crankshaft and an outer portion electrically coupled with an alternator of the engine assembly.

10. The engine assembly of claim 5, wherein an electrical interface between the grounding ring and the crankshaft of the engine assembly comprises a flywheel or a flex plate, rotationally coupled with the crankshaft and the electrical interface exhibits lower impedance than any path from the crankshaft to a main bearing.

11. The engine assembly of claim 5, comprising a flywheel rotationally coupled with the crankshaft, the flywheel electrically conductive between an inner portion mechanically coupled with the crankshaft and an outer portion electrically coupled with an alternator of the engine assembly.

12. The engine assembly of claim 5, wherein the grounding ring is a first grounding ring, the engine assembly further comprising:
a second grounding ring, wherein the grounding ring carrier is configured to retain the first grounding ring and the second grounding ring against a component which is rotationally and electrically coupled with the crankshaft.

13. The engine assembly of claim 5, further comprising a deflection lip of a dust seal, the deflection lip configured to seal against the grounding ring carrier as retained by radial grooves or straps.

14. The engine assembly of claim 5, wherein the grounding ring carrier circumscribes at least a portion of the crankshaft along a plane perpendicular to an axis of rotation of the crankshaft.

15. The engine assembly of claim 5, wherein the grounding ring carrier circumscribes an end of the crankshaft proximal to a flywheel of the engine assembly.

16. The engine assembly of claim 5, wherein the grounding ring carrier is installed at an end of the crankshaft distal to a flywheel of the engine assembly.

17. A method, comprising:
installing a grounding ring circumscribing a crankshaft of an engine assembly to form a first conductive path passing through the crankshaft and the grounding ring, wherein the first conductive path exhibits lower resistance than any second conductive path passing from the crankshaft to an engine cover through a main bearing.

18. The method of claim 17, wherein the first conductive path comprises:
a flywheel housing of the engine cover or a gear cover of the engine cover.

19. The method of claim 17, wherein the grounding ring is electrically coupled with:
the crankshaft by a silver-coated portion of the crankshaft; and
a flywheel housing of the engine assembly by a grounding ring carrier, wherein at least a portion of the grounding ring carrier is disposed between the flywheel housing and a flywheel and the grounding ring carrier is bolted to an outer face of the flywheel housing.

20. The method of claim 17, wherein the grounding ring is electrically coupled with:
the crankshaft by a silver-coated portion of the crankshaft; and
a gear housing of the engine assembly by a grounding ring carrier bolted to an outer face of the gear housing.
